(19) United States
(12) Patent Application Publication
(10) Pub. No.: US 2005/0219196 A1
(43) Pub. Date: Oct. 6, 2005

(54) Liquid crystal display

(76) Inventor: Baek-Woon Lee, Yongin-si (KR)

Correspondence Address: MCGUIREWOODS, LLP, 1750 TYSONS BLVD, SUITE 1800, MCLEAN, VA, 22102, US

(21) Appl. No.: 11/093,096

(22) Filed: Mar. 30, 2005

(30) Foreign Application Priority Data
Mar. 31, 2004 (KR) 10-2004-0022053

(51) Int. Cl. G09G 3/36

(52) U.S. Cl. 345/100

(57) ABSTRACT

A liquid crystal display is provided which includes a plurality of pixel row groups, with each pixel row group including at least one pixel row that has a plurality of pixels arranged in a matrix, and each pixel includes a first switching element and a second switching element and a pixel electrode coupled to the first switching element and the second switching element. Additionally, a plurality of gate lines connect to the first switching element and the second switching element and transmit a gate-on voltage. Also, a plurality of data lines coupled to the first switching element and the second switching element and transmitting data voltages, wherein the first switching element and the second switching element of each pixel are coupled to different gate lines and different data lines, and the pixel electrode of each pixel and the data lines adjacent to the pixel electrode form parasitic capacitances having substantially equal magnitude.

### CROSS REFERENCE TO RELATED APPLICATION

This application claims priority to and the benefit of Korean Patent Application No. 10-2004-0022053, filed on Mar. 31, 2004, which is hereby incorporated by reference for all purposes as if fully set forth herein.

### BACKGROUND OF THE INVENTION

(a) Field of the Invention

The present invention relates to a liquid crystal display.

(b) Description of Related Art

A liquid crystal display (LCD) includes a pair of panels provided with field generating electrodes and a liquid crystal (LC) layer disposed between the two panels and having dielectric anisotropy properties. The field generating electrodes generally include a plurality of pixel electrodes coupled to switching elements such as thin film transistors (TFTs) which are supplied with data voltages, and a common electrode covering an entire surface of the panel which is supplied with a common voltage. A pair of field generating electrodes that generate the electric field in cooperation with each other and a liquid crystal layer disposed therebetween form a so called a liquid crystal capacitor.

The LCD applies voltages to the field generating electrodes to generate an electric field through the liquid crystal layer, and the strength of the electric field can be controlled by adjusting the voltage across the liquid crystal capacitor. Since the electric field determines the orientation of the liquid crystal molecules in the liquid crystal layer and the orientation of the molecules determines the transmittance of light passing through the liquid crystal layer, the light transmittance is adjusted by controlling the applied voltages at each pixel, thereby obtaining desired images.

In order to prevent image deterioration when applying a unidirectional electric field for a long time, etc., the polarity of the data voltages with respect to the common voltage is reversed using an inversion type such as either every frame, every row, every column, or every dot.

Among various inversion types, a dot inversion type reverses the polarity every given number of pixels which reduces vertical crosstalk or vertical flickering due to kickback voltage, thereby improving image quality. However, the polarity inversion of the data voltages flowing in each data line required by dot inversion requires a relatively complicated driving scheme and may cause signal delays. Although a signal delay may be reduced by employing low resistivity metal, etc., such solutions complicate the manufacturing process and increase production costs.

Alternatively, a column inversion type reverses the voltage polarity every given number of pixel columns. Since the column inversion type does not reverse the polarity of the data voltages applied to each data line during one frame, signal delay problems are substantially reduced. However, the column inversion type is inferior to the dot inversion type regarding vertical crosstalk and vertical flickering, etc.

### SUMMARY OF THE INVENTION

This invention provides a liquid crystal display where each pixel has a first switching element and a second switching element, and the first switching element is coupled to a first gate line and a first data line, and the second switching element is coupled to a second gate line and a second data line such that the switching elements of a pixel are coupled to different gate lines and different data lines with respect to one another. Additionally, the first data line and the second data line each form a parasitic capacitance with the pixel, and the parasitic capacitances are equal in magnitude to one another.

The present invention also provides a liquid crystal display where each pixel has a first switching element coupled to a first gate line and a first data line, and a second switching element coupled to a second data line and a second gate line, and the first switching element has a leakage current the same as a leakage current of the second switching element.

The present invention also provides a liquid crystal display having multiple pixels where each pixel has a first switching element coupled to a first gate line and a first data line, and a second switching element coupled to a second data line and a second gate line, and adjacent data lines transmit data voltage signals having opposite polarities and each data line transmit a data voltage signal having a constant polarity.

A liquid crystal display is provided having a plurality of pixel row groups, wherein each pixel row group has at least one pixel row including a plurality of pixels arranged in a matrix and each pixel including a first switching element and a second switching element and a pixel electrode coupled to the first switching element and the second switching element. The liquid crystal display also includes a plurality of gate lines, wherein each gate line is coupled to a respective first switching element and second switching element and each gate line transmits a gate-on voltage for turning on at least one of the first switching element and the second switching element. The liquid crystal display further includes a plurality of data lines, wherein each data line is coupled to a respective first switching element and second switching element and transmits data voltages, wherein the first switching element and the second switching element corresponding to each pixel are coupled to different gate lines and different data lines with respect to the corresponding pixel, and the pixel electrode of each pixel and the data lines adjacent to the pixel electrode form respective parasitic capacitances having a substantially equal magnitude with respect to one another.

A liquid crystal display is provided including a plurality of pixel row groups, wherein each pixel row group has at least one pixel row that includes a plurality of pixels arranged in a matrix and each pixel comprises a first switching element and a second switching element. The liquid crystal display also includes a plurality of gate lines coupled to the corresponding first switching element and second switching element and transmitting a gate-on voltage for turning on the corresponding first switching element and second switching element. The liquid crystal display also includes a plurality of data lines coupled to corresponding first switching element and second switching element and transmitting data voltages, wherein the first switching element and the second switching element of each pixel are each coupled to different gate lines and different data lines, and the first switching element and the second switching element of each pixel are arranged such that leakage current through the first switching element is substantially the same as leakage current through the second switching element.

A liquid crystal display is provided including a plurality of pixel row groups, wherein each pixel row group has at least one pixel row that includes a plurality of pixels arranged in a matrix with each pixel including a first switching element and a second switching element. The liquid crystal display also includes a plurality of gate lines wherein each gate line is coupled to a corresponding first switching element and second switching element and transmits a gate-on voltage for turning on the corresponding first switching element and the second switching element. The liquid crystal display further includes a plurality of data lines wherein each data line is coupled to a corresponding first switching element and second switching element and transmits data voltages, wherein the first switching element and the second switching element of each pixel are coupled to different gate lines and different data lines, a polarity of the data voltages transmitted by adjacent data lines is opposite to one another, and the polarity of the data voltages transmitted by each data line is constant.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of an LCD according to an embodiment of the present invention.

FIG. 2 is a schematic circuit diagram of a pixel of an LCD according to an embodiment of the present invention.

FIG. 3 is a schematic circuit diagram of a pixel with corresponding gate lines and data lines according to an embodiment of the present inventions.

FIG. 4 illustrates an arrangement of switching elements for pixels for a column-type apparent inversion according to an embodiment of the present invention.

FIG. 5 illustrates an arrangement of switching elements for pixels for a 1×1 dot-type apparent inversion according to an embodiment of the present invention.

FIG. 6A and FIG. 6B illustrate arrangements of switching elements for pixels for a 2×1 dot-type apparent inversion according to an embodiment of the present invention.

### DETAILED DESCRIPTION OF EMBODIMENTS

The present invention now will be described more fully hereinafter with reference to the accompanying drawings, in which preferred embodiments of the invention are shown. The invention may, however, be embodied in many different forms and should not be construed as limited to the embodiments set forth herein. Like numerals refer to like elements throughout.

In the drawings, the thickness of layers and regions are exaggerated for clarity. It should be understood that when an element such as a layer, region or substrate is referred to as being “on” another element, it can be directly on the other element or intervening elements may also be present. In contrast, when an element is referred to as being “directly on” another element, there are no intervening elements between the two elements.

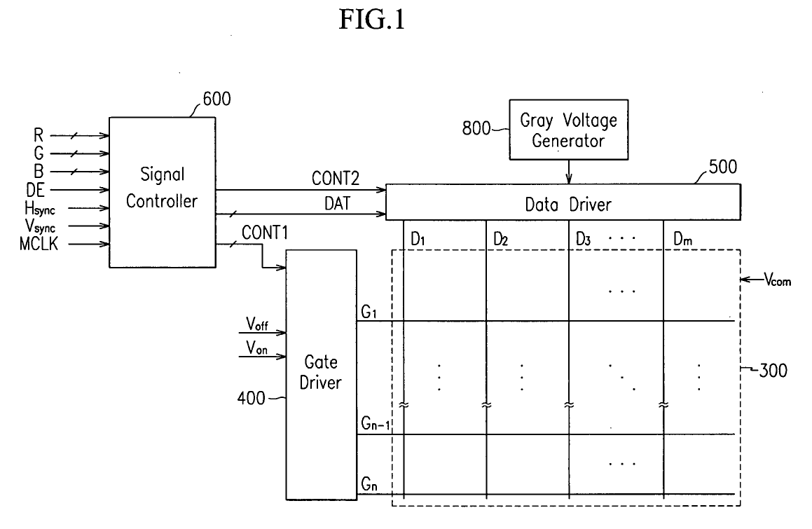

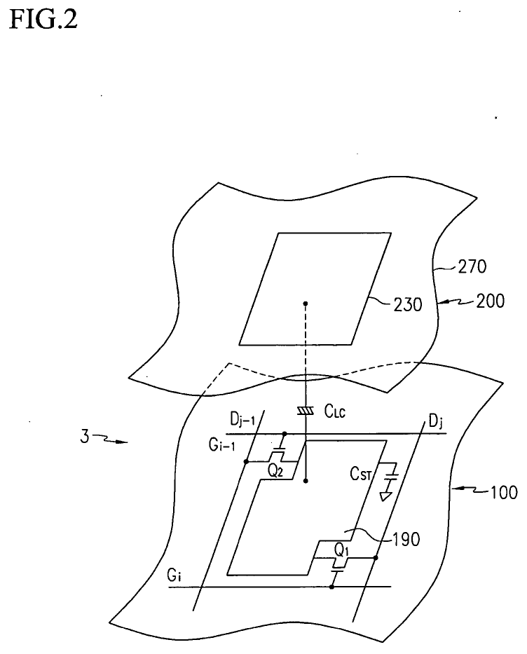

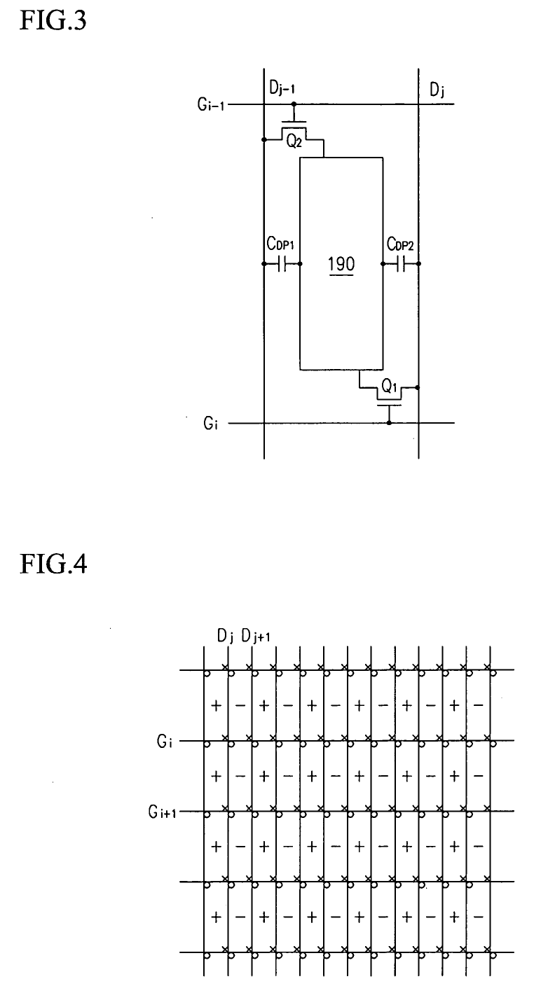

FIG. 1 is a block diagram of an LCD according to an embodiment of the present invention. FIG. 2 and FIG. 3 are equivalent circuit diagrams of a pixel of an LCD according to an embodiment of the present invention.

Referring to FIG. 1, an LCD according to an embodiment of the invention is shown having an LC panel assembly 300, with a gate driver 400, and a data driver 500 coupled to the panel assembly 300. The LCD also includes a gray voltage generator 800 coupled to the data driver 500, and a signal controller 600 for controlling the above elements. The panel assembly 300 includes a plurality of display signal lines G₁−Gₙ and D₁−Dₘ and a plurality of pixels coupled thereto and arranged substantially in a matrix.

Referring to FIG. 2, the panel assembly 300 includes a lower panel 100, an upper panel 200 and a LC layer 3 interposed therebetween. The display signal lines G₁−Gₙ and D₁−Dₘ include example lines Dⱼ₋₁ and Dⱼ as shown, and are disposed on the lower panel 100. Lines G₁−Gₙ are gate lines for transmitting gate signals (also referred to as “scanning signals”), lines D₁−Dₘ are data lines for transmitting data signals. The gate lines G₁−Gₙ are arranged in rows across the lower panel 100 and are substantially parallel to each other, while the data lines D₁−Dₘ are arranged in columns across the lower panel 100 and are substantially parallel to each other.

Each pixel includes a primary switching element Q₁ and a secondary switching element Q₂ coupled to the signal lines G₁−Gₙ and D₁−Dₘ. Each pixel also includes an LC capacitor C_{LC} and a storage capacitor C_{ST} that are coupled to the switching elements Q₁ and Q₂. In some embodiments, the storage capacitor C_{ST} may be omitted if unnecessary.

Each of the switching elements Q₁ and Q₂ includes a TFT provided on the lower panel 100 which has three terminals. The three terminals include a control terminal coupled to one of the gate lines G₁−Gₙ, an input terminal coupled to one of the data lines D₁−Dₘ, and an output terminal coupled to both the LC capacitor C_{LC} and the storage capacitor C_{ST}. The primary switching element Q₁ and the secondary switching element Q₂ are coupled to different gate lines G₁−Gₙ and different data lines D₁−Dₘ. For the example of the j-th pixel in the i-th pixel row (referred to as pixel (i, j) hereinafter) shown in FIG. 2, the primary switching element Q₁ is coupled to the (i)th gate line Gᵢ and the j-th data line Dⱼ, and the secondary switching element Q₂ is coupled to the (i−1)th gate line Gᵢ₋₁ and the (j−1)th data line Dⱼ₋₁.

The LC capacitor C_{LC} includes a pixel electrode 190 provided on the lower panel 100 and a common electrode 270 provided on an upper panel 200 as two terminals. A color filter 230 is also included on the upper panel 200. The LC layer 3 disposed between the two electrodes 190 and 270 functions as a dielectric of the LC capacitor C_{LC}. The pixel electrode 190 is coupled to the switching elements Q₁ and Q₂. The common electrode 270 is supplied with a common voltage Vcom and covers an entire surface of the upper panel 200. Alternatively to FIG. 2, other embodiments may have the common electrode 270 provided on the lower panel 100, and at least one of the electrodes 190 and 270 may also have a bar or stripe shape.

The storage capacitor C_{ST} is an auxiliary capacitor for the LC capacitor C_{LC}. The storage capacitor C_{ST} includes the pixel electrode 190 and a separate signal line, which is provided on the lower panel 100. The separate signal line overlaps the pixel electrode 190 via an insulator, and is supplied with a predetermined voltage such as the common voltage Vcom. Alternatively, the storage capacitor C_{ST} includes the pixel electrode 190 and an adjacent gate line referred to as a previous gate line, which overlaps the pixel electrode 190 via an insulator.

In a planar view as shown in FIG. 2 and FIG. 3, the pixel is assigned to a pixel area enclosed by a pair of adjacent gate lines Gᵢ₋₁ and Gᵢ and a pair of adjacent data lines Dⱼ₋₁ and Dⱼ. Referring to FIG. 3, the pixel electrode 190 is substantially rectangular and has edges parallel to the data lines Dⱼ₋₁ and Dⱼ. However, in some embodiments the pixel electrode 190 and the data lines Dⱼ₋₁ and Dⱼ may be obliquely curved. It should be noted that the pixel electrode 190 and the data lines Dⱼ₋₁ and Dⱼ may form a parasitic capacitance schematically shown as capacitors C_{DP1} and C_{DP2}, respectively.

As described above, since the primary switching element Q₁ and the secondary switching element Q₂ are coupled to different gate lines G₁−Gₙ and different data lines D₁−Dₘ, the primary switching element Q₁ and the secondary switching element Q₂ are disposed near opposite corners on a diagonal of the pixel area. The switching elements Q₁ and Q₂ may include TFTs having amorphous silicon channel portions, which may generate leakage currents in their off states.

It is preferable to arrange the structure of the pixel so that the capacitances of the parasitic capacitances C_{DP1} and C_{DP2} are equal to each other and the leakage current through the primary switching element Q₁ is substantially equal to the leakage current through the secondary switching element Q₂. For example, the primary switching element Q₁ and the secondary switching element Q₂ can be arranged to have structures and sizes substantially equivalent to each other, and they are arranged to have a 180° rotational symmetry relative to one another with respect to a center of the pixel electrode 190. Furthermore, the distance between the pixel electrode 190 and the data line Dⱼ₋₁ may be made equal to the distance between the pixel electrode 190 and the data line Dⱼ.

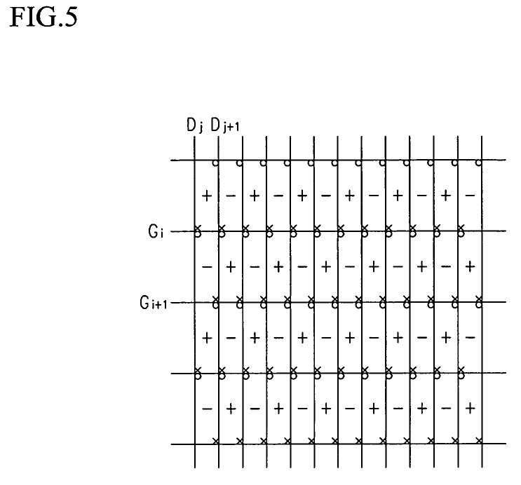

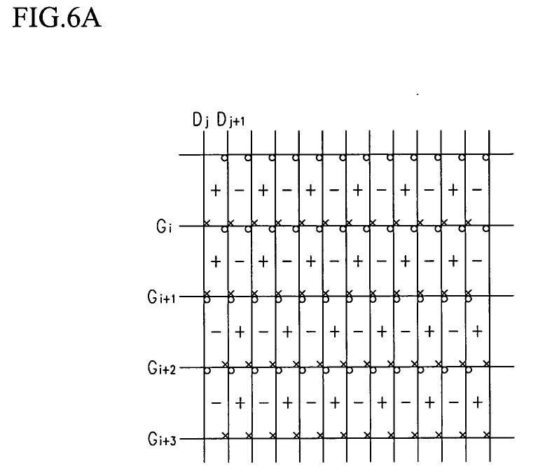

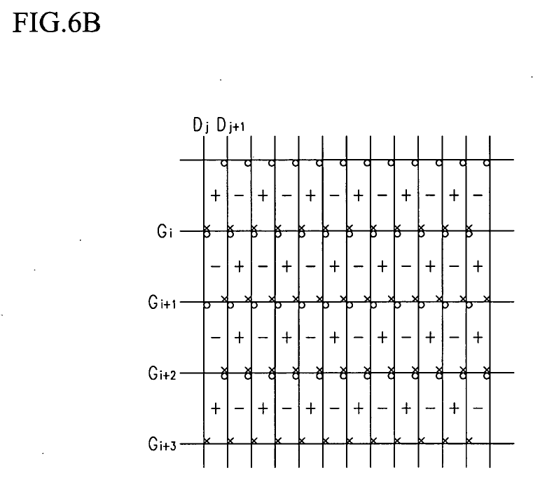

FIG. 4, FIG. 5, FIG. 6A, and FIG. 6B show several arrangements of primary and secondary switching elements of pixels according to embodiments of the present invention, as described below.

More particularly, FIG. 4, FIG. 5, FIG. 6A and FIG. 6B illustrate arrangements of switching elements of pixels according to embodiments of the present invention, including connections between primary switching elements denoted by “x” and secondary switching elements denoted by “O” and the gate lines G₁−Gₙ and the data lines D₁−Dₘ. The primary switching elements are shown disposed at lower portions of the corresponding pixels and the secondary switching elements are shown disposed at upper portions of the corresponding pixels.

Additionally, FIG. 4, FIG. 5, FIG. 6A and FIG. 6B show arrangements of gate lines and data lines where the primary switching elements of all the pixels are each coupled to the corresponding lower gate lines and the secondary switching elements of all the pixels are each coupled to the corresponding upper gate line. The position of each primary switching element and secondary switching element in the corresponding pixel is fixed or consistent across each pixel row. With regard to the signal lines, a gate line pair and a data line pair are coupled to a primary switching element and a secondary switching element which belong to different pixels.

Referring to FIG. 4, each primary switching element is coupled to the corresponding right data line of the data lines D₁−Dₘ, while each secondary switching element is similarly coupled to the corresponding left data line of the data lines D₁−Dₘ.

Referring to FIG. 5 an alternate circuit arrangement is shown which alternates the positions of the switching elements every row. In other words, the primary switching elements in adjacent pixel rows are coupled to opposite-side data lines of the data lines D₁−Dₘ. The secondary switching elements in adjacent pixel rows are similarly coupled. Among four pixel rows shown in FIG. 5, the primary switching element and the secondary switching element in the first (uppermost) and the third pixel rows are coupled to the left and the right data lines of data lines D₁−Dₘ, respectively, while the primary switching element and the secondary switching element in the second and the fourth (lowermost) pixel rows are coupled to the right and the left data lines of data lines D₁−Dₘ, respectively.

In the arrangements shown in FIG. 6A and FIG. 6B, the positions of the switching elements alternate every two pixel rows. In other words, the primary switching elements in a group of pixel rows having two adjacent pixel rows (referred to as a “pixel row group” hereinafter) occupy the same position in each respective pixel, with the secondary switching elements following a similar pattern by pixel row group. Additionally, the primary switching elements in adjacent pixel row groups occupy opposite sides of the respective pixels, with the secondary switching elements following a similar pattern by pixel row group. It should be noted that the uppermost or the lowermost single pixel row in a LC panel assembly 300 may each form a pixel row group by itself.

Among the four pixel rows shown in FIG. 6A, the primary switching elements in the first pixel row group consisting of the upper two pixel rows are coupled to the corresponding left data lines of the data lines D₁−Dₘ, and the primary switching elements in the second pixel row group consisting of the lower two pixel rows are coupled to the corresponding right data lines of data lines D₁−Dₘ. Likewise, the secondary switching elements in the first pixel row group are coupled to the corresponding right data lines of data lines D₁−Dₘ, and the secondary switching elements in the second pixel row group are coupled to the corresponding left data lines of data lines D₁−Dₘ.

Among the four pixel rows shown in FIG. 6B, the primary switching elements in the first pixel row group including the first uppermost pixel row and the fourth pixel row are coupled to the corresponding left data lines of data lines D₁−Dₘ. The primary switching elements in the second pixel row group including the second and the third pixel rows are coupled to the corresponding right data lines of data lines D₁−Dₘ. Likewise, the secondary switching elements in the first pixel row group are coupled to the corresponding right data lines of data lines D₁−Dₘ, and the secondary switching elements in the second pixel row group are coupled to the corresponding left data lines of data lines D₁−Dₘ.

Consequently, the positions of the switching elements may alternate every third pixel row. To summarize, the configuration of the switching elements shown in FIG. 5, FIG. 6A and FIG. 6B arrange the primary/secondary switching elements in each pixel row group, which includes at least one pixel row, to occupy a first position and arrange the primary/secondary switching elements in adjacent pixel row groups to occupy second positions which is oppositely located within the pixel to the first position.

For a color display using an LCD, each pixel uniquely represents one of the primary colors (i.e., spatial color division) or each pixel sequentially represents each of the primary colors in turn (i.e., temporal division) such that the spatial or temporal sum of the primary colors are recognized as a desired color. FIG. 2 shows an example of spatial color division where each pixel includes a color filter 230 representing one of the primary colors in an area of the upper panel 200 facing the pixel electrode 190. Alternatively, the color filter 230 may be provided on or under the pixel electrode 190 on the lower panel 100.

An example of a set of primary colors includes red, green, and blue colors. The pixels having the red, green, and blue color filters are referred to as red, green, and blue pixels, respectively. A representative arrangement of red, green, and blue pixels is a stripe arrangement where each pixel row includes red, green, and blue pixels arranged in turn and each pixel column represents only one color. Additionally, one or more polarizers (not shown) may be attached to at least one of the panels 100 and 200.

Referring to FIG. 1 again, the gray voltage generator 800 generates two sets of a plurality of gray voltages related to the transmittance of the pixels. The gray voltages in one set have a positive polarity with respect to the common voltage Vcom, while those in the other set have a negative polarity with respect to the common voltage Vcom.

The gate driver 400 is coupled to the gate lines G₁−Gₙ of the panel assembly 300 and synthesizes the gate-on voltage Von and the gate-off voltage Voff from an external device to generate gate signals for application to the gate lines G₁−Gₙ. The data driver 500 is coupled to the data lines D₁−Dₘ of the panel assembly 300 and applies data voltages to the data lines D₁−Dₘ, where the data voltages are selected from the gray voltages supplied from the gray voltage generator 800.

The drivers 400 and 500 may include at least one integrated circuit (IC) chip mounted on the panel assembly 300 or on a flexible printed circuit (FPC) film in a tape carrier package (TCP) type, which are attached to the LC panel assembly 300. Alternatively, the drivers 400 and 500 may be integrated into the panel assembly 300 along with the display signal lines G₁−Gₙ and D₁−Dₘ and the TFT switching elements Q₁ and Q₂. The signal controller 600 controls the gate driver 400 and the data driver 500.

The operation of the above-described LCD includes the signal controller 600 being supplied with input image signals R, G and B and input control signals for controlling the display thereof. Input control signals may include, for example, a vertical synchronization signal Vsync, a horizontal synchronization signal Hsync, a main clock MCLK, and a data enable signal DE from an external graphics controller. The signal controller 600 generates gate control signals CONT1 and data control signals CONT2. The signal controller 600 also processes the image signals R, G and B to make processed image signals suitable for the operation of the panel assembly 300 on the basis of the input control signals and the input image signals R, G and B. The signal controller 600 then transmits the gate control signals CONT1 to the gate driver 400, and transmits processed image signals DAT and the data control signals CONT2 to the data driver 500.

The gate control signals CONT1 include a scanning start signal STV as an instruction to start scanning and additionally includes at least a clock signal for controlling the output time of the gate-on voltage Von. The gate control signals CONT1 may further include an output enable signal OE for defining the duration of the gate-on voltage Von.

The data control signals CONT2 include a horizontal synchronization start signal STH to indicate the start of data transmission for a row of pixels. The data control signals CONT2 also include a load signal LOAD to instruct the application of the data voltages to the data lines D₁−Dₘ, and a data clock signal HCLK. The data control signal CONT2 may further include an inversion signal RVS for reversing the polarity of the data voltages with respect to the common voltage Vcom.

In response to the data control signals CONT2 from the signal controller 600, the data driver 500 receives a packet of the image data DAT for the pixel row from the signal controller 600. The data driver 500 converts the image data DAT into analog data voltages selected from the gray voltages supplied from the gray voltage generator 800, and applies the data voltages to the data lines D₁−Dₘ.

The gate driver 400 applies the gate-on voltage Von to the gate line G₁−Gₙ in response to the gate control signals CONT1 received from the signal controller 600. Since each gate line of gate lines G₁−Gₙ is coupled to the primary switching elements Q₁ of the pixel row and the secondary switching elements Q₂ of the next pixel row, the primary switching elements Q₁ of the pixel row and the secondary switching elements Q₂ of the next pixel row are simultaneously turned on. The data voltages applied to the data lines D₁−Dₘ are consequently supplied to two rows of pixels through the activated switching elements Q₁ and Q₂.

The difference between the data voltage and the common voltage Vcom is represented as a voltage across the LC capacitor C_{LC}, and is referred to as a pixel voltage. The LC molecules of the LC layer 3 in the LC capacitor C_{LC} have orientations which depend on the magnitude of the pixel voltage. The resulting molecular orientations determine the polarization of light passing through the LC layer 3. The polarizer of each pixel then converts the light polarization into the light transmittance based on the amount of polarization done by the LC layer 3.

A pixel row supplied with the data voltages for a previous pixel row through the secondary switching elements Q₂ is also supplied with its own data voltages through the primary switching elements Q₁ after a horizontal period. The horizontal period is denoted by “1H” and is equal to one period of the horizontal synchronization signal Hsync and the data enable signal DE.

By repeating this procedure by a unit of the horizontal period, all gate lines G₁−Gₙ are sequentially supplied with the gate-on voltage Von during a frame, thereby applying the data voltages to all pixels. When the next frame starts after finishing one frame, the inversion control signal RVS applied to the data driver 500 is applied such that the polarity of the data voltages is reversed (which is referred to as “frame inversion”).

Other than the frame inversion, the data driver 500 varies the polarity of the data voltages flowing in the data lines during one frame, thereby varying the polarity of the pixel voltages. Since the connections between the pixels and the data lines D₁−Dₘ vary as shown in FIG. 4, FIG. 5, FIG. 6A and FIG. 6B, the polarity inversion pattern generated by the data driver 500 is different from that of the pixel voltages appearing on the panel assembly 300. Hereinafter, the polarity inversion of the data driver 500 is referred to as “driver inversion” and the polarity inversion appearing on the panel assembly 300 is referred to as “apparent inversion.” It should be noted that the polarity of the pixel voltage of a pixel is determined by the polarity of the data voltage transmitted by the pixel's primary switching element since the voltage charge in the pixel by the secondary switching element remains for only one horizontal period that is much shorter than one frame.

FIG. 4, FIG. 5, FIG. 6A and FIG. 6B show various example embodiments where the driver inversion is a column inversion, and the polarity of the data voltages in each data line is fixed and the polarity of the data voltages in each adjacent data lines is opposite.

Referring to FIG. 4, the apparent inversion is done by a column inversion like the driver inversion since the position of each primary switching element within the corresponding pixel is the same for all the pixels. Referring to FIG. 5, the apparent inversion is done by a 1×1 dot inversion since the position of each switching element in the corresponding pixel is interchanged every pixel row. Similarly, the apparent inversion for the circuits shown in FIG. 6A and FIG. 6B is done by 2×1 dot inversion since the position of each switching element in the corresponding pixel is interchanged every two pixel rows.

The opposite positioning of the primary switching element and the secondary switching element for a pixel as described above reduces the vertical crosstalk. Generally, vertical crosstalk is generated by the voltage variation of pixel electrodes due to the parasitic capacitance between the pixel electrodes and adjacent data lines, or due to the leakage current of turned-off switching transistors.

Referring to FIG. 3, a voltage variation of a pixel electrode due to the parasitic capacitance and leakage current is described as follows. As discussed above, the pixel electrode 190 is coupled to gate lines Gᵢ₋₁ and Gᵢ and data lines Dⱼ₋₁ and Dⱼ through transistors Q₁ and Q₂. Also, a parasitic capacitance represented by capacitors C_{DP1} and C_{DP2}, is formed between the pixel electrode 190 and the two data lines Dⱼ₋₁ and Dⱼ. The parasitic capacitors and their parasitic capacitances are denoted by the reference characters C_{DP1} and C_{DP2}, respectively.

A voltage variation ΔV of the pixel electrode 190 due to the parasitic capacitances C_{DP1} and C_{DP2} between the pixel electrode 190 and the data line Dⱼ₋₁ and Dⱼ is given by:

$$Δ V = \frac{{C}_{DP1} ( V1 - {V1}^{′} ) + {C}_{DP2} ( V2 - {V2}^{′} )}{{C}_{LC} + {C}_{ST} + {C}_{GS} + {C}_{DP1} + {C}_{DP2}} , \qquad ( 1 )$$

where V1 and V2 denote voltages of the data lines Dⱼ₋₁ and Dⱼ, respectively, when the pixel electrode 190 is charged. V1′ and V2′ denote voltages of the data lines Dⱼ₋₁ and Dⱼ, respectively, after the pixel electrode 190 is charged, CGS denotes parasitic capacitance between the gate and source of the transistors Q₁ and Q₂. C_{LC} denotes the liquid crystal capacitance, and C_{ST} denotes a storage capacitance. In the example, it is assumed that the LCD is subjected to a column inversion and that the data voltages in the data lines Dⱼ₋₁ and Dⱼ represent the same gray.

Since (V2−Vcom)=−(V1−Vcom) and (V2′−Vcom)=−(V1′−Vcom), the condition that (V2−V2′)=−(V1−V1′) is satisfied. Accordingly, Equation 1 may be expressed as:

$$Δ V = \frac{Δ {C}_{DP} ( V1 - {V1}^{′} )}{{C}_{LC} + {C}_{ST} + {C}_{GS} + {C}_{DP1} + {C}_{DP2}} , \qquad ( 2 )$$

where ΔC_{DP}=C_{DP1}−C_{DP2}.

Additionally, the voltage variation ΔV due to the leakage current is given by:

$$Δ V = \frac{( Ioff1 - Ioff2 ) \times t}{{C}_{LC} + {C}_{ST} + {C}_{GS} + {C}_{DP1} + {C}_{DP2}} ,$$

where it is a time for applying data voltages to the data line Dⱼ which is different from the voltage charge in the pixel electrode 190. Ioff1 is a leakage current through the primary switching element Q₁ between the pixel electrode 190 and the data line Dⱼ, and Ioff2 is a leakage current through the secondary switching element Q₂ between the pixel electrode 190 and the data line Dⱼ₋₁. The leakage currents Ioff1 and Ioff2 are either positive or negative depending on the sign of the voltage difference between the pixel electrode 190 and the data lines Dⱼ₋₁ and Dⱼ.

As shown in FIG. 3, the switching elements Q₁ and Q₂ have substantially the same structure as one another and are disposed opposite each other on a diagonal through the pixel electrode 190. Thus, the pixel electrode 190 and switching elements Q₁ and Q₂ have a 180-degree rotational symmetry with respect to the center of the pixel electrode 190. Therefore, the geometrical structure of the pixel electrode 190 with respect to the adjacent data lines Dⱼ₋₁ and Dⱼ₊is also symmetrical. Accordingly, the parasitic capacitances C_{DP1} and C_{DP2} between the pixel electrode 190 and the two data lines Dⱼ₋₁ and Dⱼ are substantially equal in magnitude to one another such that the variation of the pixel voltage due to the difference between the parasitic capacitances C_{DP1} and C_{DP2} substantially vanishes.

In addition, since the primary switching element Q₁ and the secondary switching element Q₂ are coupled to the data lines transmitting the data voltages having opposite polarities, the leakage current Ioff2 comes into the pixel electrode 190 through the secondary switching element Q₂ and the leakage current Ioff1 goes out of the pixel electrode 190 through the primary switching element Q₁. Alternatively, the leakage current Ioff1 comes into the pixel electrode 190 through the primary switching element Q₁ and the leakage current Ioff2 goes out of the pixel electrode 190 through the secondary switching element Q₂. Because the structures or sizes of the primary switching element Q₁, and the secondary switching element Q₂ are substantially the same, the magnitudes of the leakage current Ioff1 and Ioff2 are substantially the same such that Ioff1−Ioff2≈0. Accordingly, the above-described configuration substantially reduces the voltage variation ΔV of the pixel electrode 190, thereby greatly reducing the vertical crosstalk.

Additionally, FIG. 5, FIG. 6A and FIG. 6B show that half of the pixels coupled to each data line D₁−Dₘ belong to a first pixel column, while the other half of the pixels belong to another pixel column adjacent to the first pixel column. In addition, half of the pixels in each pixel column are coupled to a respective data line of the data lines D₁−Dₘ, while the other half of the pixels therein are coupled to another respective data line of the data lines D₁−Dₘ adjacent thereto. Therefore, each data line D₁−Dₘ transmits the data voltages for a pixel column during half of a frame and transmits the data voltages for another pixel column during the other half of the frame, and two adjacent data lines D₁−Dₘ alternately transmit the data voltages for a pixel column.

Since the pixels in a column represent the same gray voltage value, the data voltages for the pixel column will usually have the same absolute magnitude relative to the common voltage Vcom. Accordingly, two adjacent data lines of the data lines D₁−Dₘ will usually transmit the data voltages that have equal magnitudes but have opposite polarities in an alternate manner, which further decreases the voltage variation ΔV of the pixel electrodes 190 to further reduce vertical crosstalk.

The dot-type apparent inversion shown in FIG. 5, FIG. 6A and FIG. 6B disperses the difference in the luminance due to the kickback voltages between the positive-polarity pixel voltages and the negative-polarity pixel voltages, thereby reducing vertical line defect. Furthermore, the arrangement of the switching elements of the pixels shown in FIG. 5, FIG. 6A and FIG. 6B realize an N×1 dot-type apparent inversion for a given column-type driver inversion. The column-type driver inversion increases material choices available for the data lines and thus it is easier to find a material suitable for simplifying the manufacturing process. In addition, the charging time for the data voltage signals into the pixels is increased to improve the response time of the LCD, and thus the width of the data lines can be reduced to increase the aperture ratio since the signal delay is relatively insignificant. Furthermore, the increase of the variation of the contact resistance between the data lines and other devices will typically not cause a significant signal delay that may generate a vertical line defect, and an increase of the resistance of the data lines due to any repair operations of the data lines will typically not cause a significant problem. Moreover, the loss or reduction of the data voltage due to a signal delay is decreased to reduce power consumption by the LCD, thereby reducing the heat dissipation of driving devices.

The dual switching element configuration has a further advantage in repairing defects. For example, referring to FIG. 2 and FIG. 3, some circuit defects cause the primary switching element Q₁ to be inoperable due to a short-circuit between the terminals of the Q₁ or between the terminal(s) and other conductors such as the data line Dⱼ or the gate line Gᵢ. When such a circuit defect occurs, the pixel electrode 190 is always coupled to the data line Dⱼ or the gate line Gᵢ and receives a continuously varying pixel voltage signal or an almost constant pixel voltage signal. Such a defect may be repaired by having the primary switching element Q₁ decoupled from the data line D₁−Dₘ of the pixel electrode 190 by laser cutting, etc. With the primary switching element Q₁ decoupled, the pixel electrode 190 is charged with the data voltages for another pixel adjacent thereto through the secondary switching element Q₂. Although the charged voltage is not a target voltage, the overall image is not significantly affected since the charge voltage is a target voltage of the adjacent and therefore most likely similarly charged pixel.

When the primary switching element Q₁ is inoperable due to disconnection of the primary switching element Q₁ from the data line Dⱼ, the gate line Gᵢ, or the pixel electrode 190 repair is not required since the pixel electrode 190 is charged with the data voltages for another pixel adjacent thereto through the secondary switching element Q₂ as described above.

Since the secondary switching element Q₂ is irrelevant to the charging of the target voltage of the pixel electrode 190, the electrical disconnection of the pixel electrode 190 from the data line Dⱼ₋₁ when repairing the short-circuit of the secondary switching element Q₂ causes no operational problems for the pixel electrode 190. Accordingly, disconnecting the secondary switching element Q₂ has no negative affect on the pixel electrode 190 function.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A liquid crystal display, comprising:
a plurality of pixel row groups, wherein each pixel row group comprises at least one pixel row including a plurality of pixels and each pixel including a first switching element and a second switching element and a pixel electrode coupled to the first switching element and the second switching element;
a plurality of gate lines, wherein each gate line is coupled to a respective first switching element and second switching element and each gate line transmits a gate-on voltage for turning on at least one of the first switching element and the second switching element; and
a plurality of data lines, wherein each data line is coupled to a respective first switching element and second switching element and transmits data voltages,
wherein the first switching element and the second switching element corresponding to each pixel are coupled to different gate lines and different data lines with respect to the corresponding pixel, and the pixel electrode of each pixel and the data lines adjacent to the pixel electrode form respective parasitic capacitances having a substantially equal magnitude with respect to one another.

2. The liquid crystal display of claim 1, wherein the first switching element and the second switching element in each pixel are arranged such that leakage current through the first switching element is substantially the same as leakage current through the second switching element.

3. The liquid crystal display of claim 2, wherein the first switching element and the second switching element in each pixel are arranged such that the first switching element and the second switching element have rotational symmetry with respect to a center of the pixel electrode in the pixel.

4. The liquid crystal display of claim 1, wherein a polarity of the data voltages transmitted by adjacent data lines is opposite to one another.

5. The display device of claim 4, wherein the polarity of the data voltages transmitted by each data line is constant.

6. The liquid crystal display of claim 1, wherein the first switching elements are coupled to data lines at the same sides of respective pixels relative to one another, and the second switching elements are coupled to data lines at the same sides of a respective pixels relative to one another.

7. The liquid crystal display of claim 1, wherein the first switching elements in a pixel row group are each connected to a data line at a first side of each respective pixel, the second switching elements in the pixel row group are each connected to a data line at a second side of each respective pixel, and the first switching elements in an adjacent pixel row group are each connected to a data line at a second side of each respective pixel, and the second switching elements in the adjacent pixel row group are each connected to a data line at a first side of each respective pixel, wherein a first side is opposite a second side of each respective pixel.

8. A liquid crystal display comprising:
a plurality of pixel row groups, wherein each pixel row group comprises at least one pixel row that includes a plurality of pixels and each pixel comprises a first switching element and a second switching element;
a plurality of gate lines coupled to the corresponding first switching element and second switching element and transmitting a gate-on voltage for turning on the corresponding first switching element and second switching element; and
a plurality of data lines coupled to corresponding first switching element and second switching element and transmitting data voltages,
wherein the first switching element and the second switching element of each pixel are each coupled to different gate lines and different data lines, and the first switching element and the second switching element of each pixel are arranged such that leakage current through the first switching element is substantially the same as leakage current through the second switching element.

9. The liquid crystal display of claim 8, wherein each pixel further comprises a pixel electrode coupled to the corresponding first switching element and second switching element.

10. The liquid crystal display of claim 9, wherein the first switching element and the second switching element in each pixel are arranged such that the first switching element and the second switching element have rotational symmetry with respect to one another about a center of the pixel electrode in the pixel.

11. The liquid crystal display of claim 8, wherein a polarity of the data voltages transmitted by adjacent data lines is opposite to one another.

12. The display device of claim 11, wherein polarity of the data voltages transmitted by each data line is constant.

13. The liquid crystal display of claim 8, wherein the first switching elements are coupled to data lines at the same sides of respective pixels relative to one another, and the second switching elements are coupled to data lines at the same sides of respective pixels relative to one another.

14. The liquid crystal display of claim 8, wherein the first switching elements in a pixel row group are each connected to a data line at a first side of each respective pixel, the second switching elements in the pixel row group are each connected to a data line at a second side of each respective pixel, and the first switching elements in an adjacent pixel row group are each connected to a data line at a second side of each respective pixel, and the second switching elements in the adjacent pixel row group are each connected to a data line at a first side of each respective pixel, wherein a first side is opposite a second side of each respective pixel.

15. A liquid crystal display comprising:
a plurality of pixel row groups, wherein each pixel row group comprises at least one pixel row that includes a plurality of pixels with each pixel including a first switching element and a second switching element;
a plurality of gate lines wherein each gate line is coupled to a corresponding first switching element and second switching element and transmits a gate-on voltage for turning on the corresponding first switching element and second switching element; and
a plurality of data lines wherein each data line is coupled to a corresponding first switching element and second switching element and transmits data voltages, wherein the first switching element and the second switching element of each pixel are coupled to different gate lines and different data lines, a polarity of the data voltages transmitted by adjacent data lines is opposite to one another, and the polarity of the data voltages transmitted by each data line is constant.

16. The liquid crystal display of claim 15, wherein the first switching elements are coupled to data lines at the same sides of respective pixels relative to one another, and the second switching elements are coupled to data lines at the same sides of a respective pixels relative to one another.

17. The liquid crystal display of claim 15, wherein the first switching elements in a pixel row group are each connected to a data line at a first side of each respective pixel, the second switching elements in the pixel row group are each connected to a data line at a second side of each respective pixel, and the first switching elements in an adjacent pixel row group are s each connected to a data line at a second side of each respective pixel, and the second switching elements in the adjacent pixel row group are each connected to a data line at a first side of each respective pixel, wherein a first side is opposite a second side of each respective pixel.
